(19) United States
(12) Patent Application Publication
(10) Pub. No.: US 2006/0250362 A1
(43) Pub. Date: Nov. 9, 2006

(54) Input device capable of using cabled mouse and wireless mouse

(75) Inventor: Kuei Lin Chung, Taipei County (TW)

Correspondence Address: BACON & THOMAS, PLLC, 625 SLATERS LANE, FOURTH FLOOR, ALEXANDRIA, VA, 22314, US

(73) Assignee: ARESON TECHNOLOGY CORP., Taipei County (TW)

(21) Appl. No.: 11/124,089

(22) Filed: May 9, 2005

(51) Int. Cl. G09G 5/08

(52) U.S. Cl. 345/163

(57) ABSTRACT

An input device adaptable to a cabled or a wireless mouse includes a receiver connected to a PC via transmission cable and provided on its slope a first latch, a second latch being disposed on a slope of a wireless mouse that contains a charging battery; both latches being locked to each other for the PC to charge the wireless mouse when the battery power in the wireless mouse is at low lever without interrupting the connection between the wireless mouse and the receiver.

### BACKGROUND OF THE INVENTION

1. Field of the Invention

The present invention is related to an input device capable of using a cabled and a wireless mouse, and more particularly to one that the wireless mouse can be charged by a PC connected to it through a receiver to maintain working with the PC and improve work efficiency.

2. Description of the Prior Art

A mouse is a must of computer peripherals. Before the introduction of a wireless mouse, it takes a transmission cable to connect the mouse to a PC. However, the use of the cabled mouse is not ideal since the user always fails to put it on at location best comfortable to his personal preference in working with the PC due to that the presence of the transmission cable is getting in the way.

Referring to FIG. 1 of the accompanying drawings, a wireless mouse of the prior art is provided with a receiver 100 connected to a PC with a transmission cable 110 for transmitting control signals and power from the PC to the receiver 100 thus for the receiver 100 to have sufficient power supply for operation while being subject to the control by the PC. Furthermore, the receive 100 is adapted with a wireless mouse 200 containing a transmitter (not illustrated) to send the action signals of the wireless mouse 200 to the PC through the receiver 100 thus to complete connection with the PC. The wireless mouse 200 contains one cell or two cells as the case may be to supply the power to the transmitter. However, the power source is prevented from following the same pattern as that of the signals to be transmitted without a cable, meaning that the transmitter in the wireless mouse has to rely upon the cell. Therefore, the PC operation has to be interrupted for the user to replace the cell at low level of power before resuming his operation with the PC. The used cell also creates environmental problem.

### SUMMARY OF THE INVENTION

The primary purpose of the present invention is to provide an input device capable of using cabled mouse and wireless mouse that allows the wireless mouse to be charged from the source of the PC without interrupting the on-going operation with the PC while eliminating the environmental problem since no cell is needed for the wireless mouse. To achieve the purpose, a receiver is provided to the input device and connected to a PC by means of a transmission cable; a contact is disposed on the surface for the wireless mouse to be connected to via the receiver and subject to the control by the PC; and the wireless mouse is provided with a charging battery connected through a conductor to the metal contact disposed on the surface of the mouse for the PC to charge the mouse through the receiver.

Another purpose of the present invention is to provide an input device capable of using cabled mouse and wireless mouse. Wherein, the charging process is protected from interruption. To achieve the purpose, a first latch is provided on the receiver and a second matching latch is provided on the surface of the wireless mouse that are locked to each other in the course of the charging process to ensure the engagement of the contact on the receiver and the metal contact on the wireless mouse.

### BRIEF DESCRIPTION OF THE DRAWINGS

FIG. 1 is a schematic view showing an input device of the prior art.

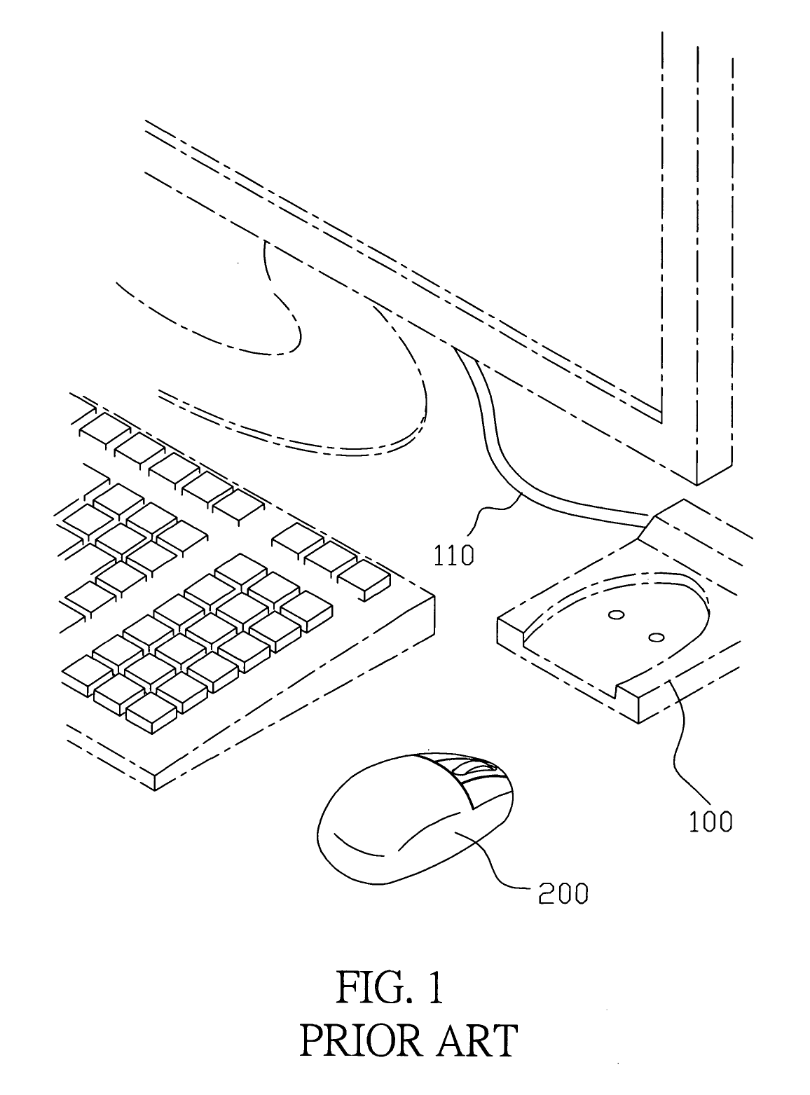

FIG. 2 is an exploded view of a preferred embodiment of the present invention.

FIG. 3 is a schematic view showing the preferred embodiment of the present invention as assembled.

FIG. 4 is a schematic view showing that the preferred embodiment of the present invention is adapted to a PC.

FIG. 5 is a schematic view showing the process of the preferred embodiment of the present invention is being charged.

### DETAILED DESCRIPTION OF THE PREFERRED EMBODIMENTS

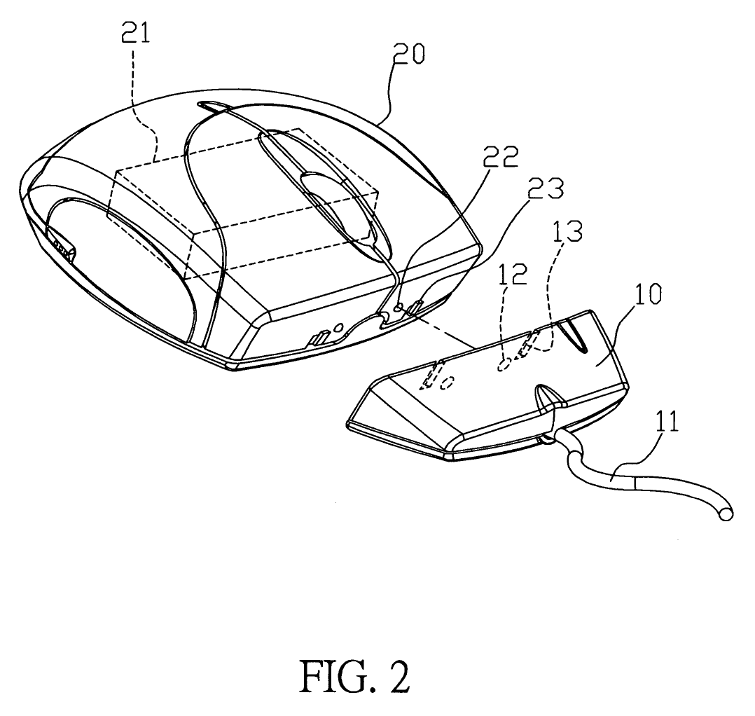

Referring to FIGS. 2, 3, and 4, a preferred embodiment of the present invention is disposed with a receiver 10 in any form as appropriate and is made in substantially rectangular shape in the preferred embodiment. The receiver 10 contains an element to receive radio signals and is connect to a PC 30 with a transmission cable 11 for the PC 30 to transmit power to and as required for the operation by the receiver 10 via the transmission cable 11 while transmitting signals received by the receiver 10 to the PC 30 via the transmission cable for processing. Whereas the function of the transmission cable 11 in the preferred embodiment is the same to that provided by a wireless mouse of the prior art, no description would be elaborated herein.

Multiple metal contacts 12 are provided on any given surface of the receiver 10 with each contact 12 made in a shape of conic point and are connected to a power conductor (not illustrated) of the transmission cable 11. A first clasp 13 is provided on the slope where those contacts 12 are disposed and the clasp 13 relates to a recessed insertion slot in the preferred embodiment of the present invention.

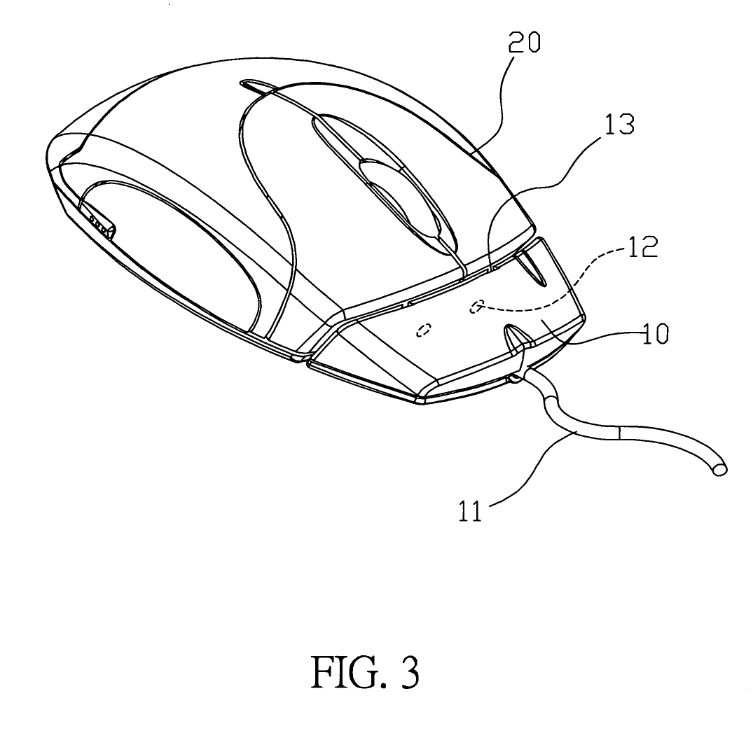

The receiver 10 also works with a wireless mouse 20 containing a charging battery 21 connected to a built-in transmitter (not illustrated) of the wireless mouse 20 and provided on its surface multiple metal contacts 22 each in conical form corresponding to those contacts 12 on the surface of the receiver 10. Those metal contacts 22 are connected to the charging battery 21 via a circuit and a second clasp 23 is provided on the slope of wireless mouse 20 where those metal contacts 22 are disposed. The second clasp 23 in this preferred embodiment is related to a raised insertion member to snap on to the first clasp 13 on the receiver 10 as illustrated in FIG. 3.

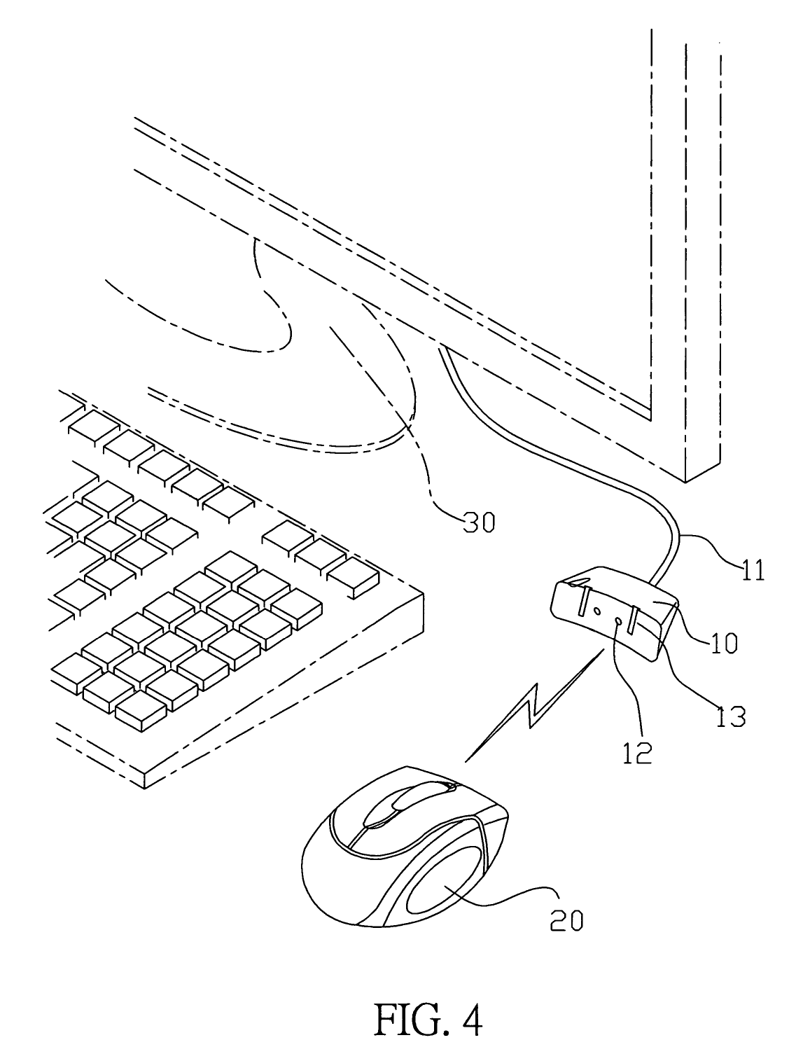

Now referring to FIGS. 2 and 4, the receiver 10 is connected to the PC 30 through the transmission cable 11 for the receiver 10 to pick up the signals within its reception range that are sent from the transmitter in the wireless mouse 20 and to send those signals to the PC 30 for processing through the transmission cable 11 before being displayed on the monitor for working purpose by moving the coordinates with the wireless mouse 20.

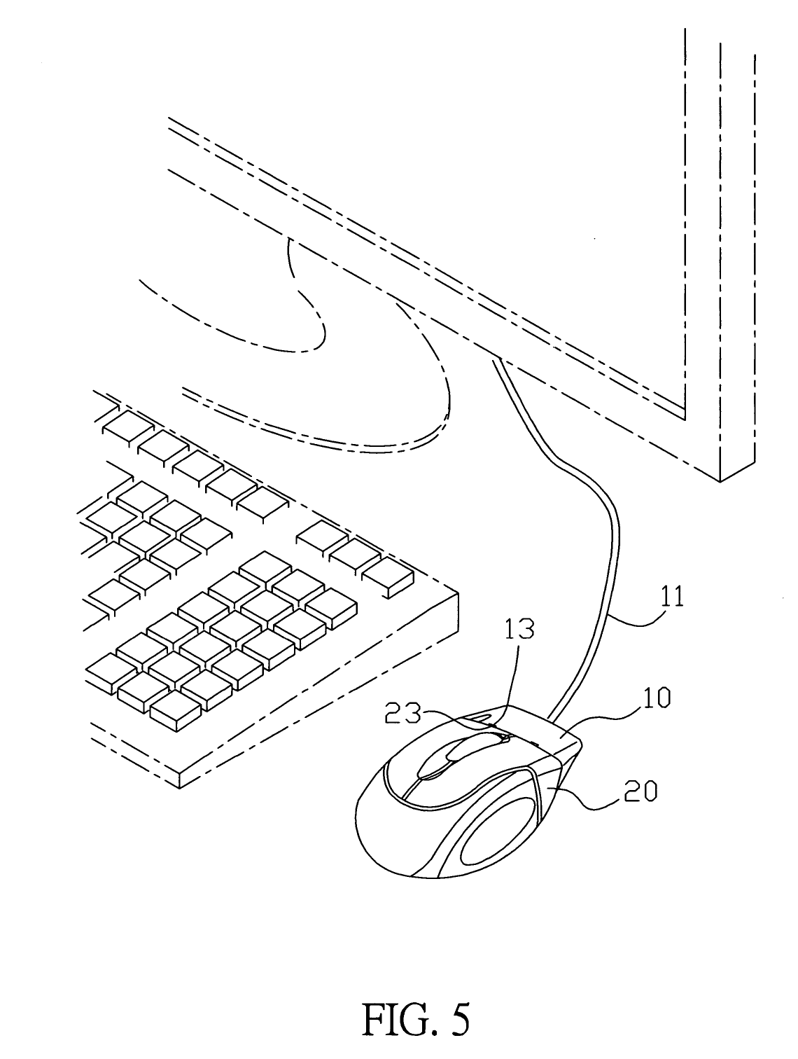

Furthermore, as illustrated in FIGS. 3 and 5, when the power of the battery 21 in the wireless mouse is at low level, the receiver 10 and the wireless mouse are incorporated to each other by snapping the second clasp 23 into the first clasp 13 for those contracts 12, 22 respectively from the receiver 10 and the wireless mouse 20 to contact one another to be conducted. Once conducted, the power supply from the PC 30 is delivered to those contact 12 through the transmission cable 11 to charge the battery 21 by contacting those metal contacts 22. Meanwhile, the wireless mouse 20 remains functioning through the receiver 10. Accordingly, the present invention improves the work efficiency since the work will not be interrupted and helps achieve environmental purpose without having to dump the used cells.

The prevent invention provides an improved construction of an input device that is adaptable to cabled mouse and wireless mouse, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. An input device capable of using cabled mouse and wireless mouse includes a receiver connected to a PC working on the power supplied from the PC for signal connection, provided with a first clasp and multiple contacts connected to the power source of the PC; and a wireless mouse working also in conjunction with the receiver, containing a built-in charging battery, a second clasp on its surface, multiple metal contacts connected to the charging battery to contact those contacts from the receiver for conduction to deliver power supplied from the PC to charge the charging battery when staying low level without interrupting the operation of the wireless mouse.

2. The input device capable of using cabled mouse and wireless mouse of claim 1, wherein the first clasp relates to a recessed insertion slot.

3. The input device capable of using cabled mouse and wireless mouse of claim 1, wherein the second clasp relates to a raised insertion member.

4. The input device capable of using cabled mouse and wireless mouse of claim 1, wherein the first clasp is provided on the slope of the receiver.

5. The input device capable of using cabled mouse and wireless mouse of claim 1, wherein the second clasp is provided on the slope of the wireless mouse.
